(19) United States
(12) Patent Application Publication
(10) Pub. No.: US 2014/0164120 A1
(43) Pub. Date: Jun. 12, 2014

(54) COUPON DISPLAY SYSTEM

(71) Applicants: Brian William Payne, San Jose, CA (US); Liem Duy Nguyen, San Jose, CA (US); Sarmishta Pantham, Fremont, CA (US); Noah Batterson, Savannah, GA (US)

(72) Inventors: Brian William Payne, San Jose, CA (US); Liem Duy Nguyen, San Jose, CA (US); Sarmishta Pantham, Fremont, CA (US); Noah Batterson, Savannah, GA (US)

(73) Assignee: eBay Inc., San Jose, CA (US)

(21) Appl. No.: 13/708,449

(22) Filed: Dec. 7, 2012

(51) Int. Cl. G06Q 30/02

(52) U.S. Cl. CPC G06Q 30/0261
USPC 705/14.58

(57) ABSTRACT

According to various exemplary embodiments, a redemption location associated with each of one or more coupons is determined, and a current location of a mobile device of a user is determined. Thereafter, for each of the coupons, a distance between the redemption location of the respective coupon and the current location of the mobile device of the user is calculated. The coupons are then displayed, via a user interface in the mobile device, in a visual arrangement that illustrates the proximity of the user to the redemption locations associated with each of the coupons.

### TECHNICAL FIELD

The present application relates generally to electronic user interfaces and, in one specific example, to a coupon display system.

### BACKGROUND

Coupons are generally tickets or documents that can be exchanged for a financial discount when purchasing a product. For example, coupons may be issued by a retailer for use in the retailer's stores as part of a sales promotion. Such coupons may be distributed to a consumer via, for example, internet websites, newspapers, magazines, regular mail, and so on. In order to redeem the coupon and obtain the financial discount for a product being purchased, the consumer typically presents the coupon in the appropriate retail store at the time of purchase.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 is a flow-chart illustrating an example method, according to various embodiments.

FIG. 4 illustrates examples of coupons, according to various embodiments.

FIG. 5 illustrates an example of retailer information, according to various embodiments.

FIG. 6 illustrates an example of coupon management information, according to various embodiments.

FIG. 7 illustrates an example of coupon management information, according to various embodiments.

FIGS. 8-10 illustrate examples of user interfaces displayed by a coupon display system, according to various exemplary embodiments.

FIG. 11 is a flowchart illustrating an example method, according to various embodiments.

FIG. 12 illustrates an example of coupon management information, according to various embodiments.

FIGS. 13-15 illustrate examples of user interfaces displayed by a coupon display system, according to various exemplary embodiments.

FIG. 16 is a diagrammatic representation of a machine in the example form of a computer system within which a set of instructions, for causing the machine to perform any one or more of the methodologies discussed herein, may be executed.

### DETAILED DESCRIPTION

Example methods and systems to display coupons are described. In the following description, for purposes of explanation, numerous specific details are set forth in order to provide a thorough understanding of example embodiments. It will be evident, however, to one skilled in the art that the present invention may be practiced without these specific details.

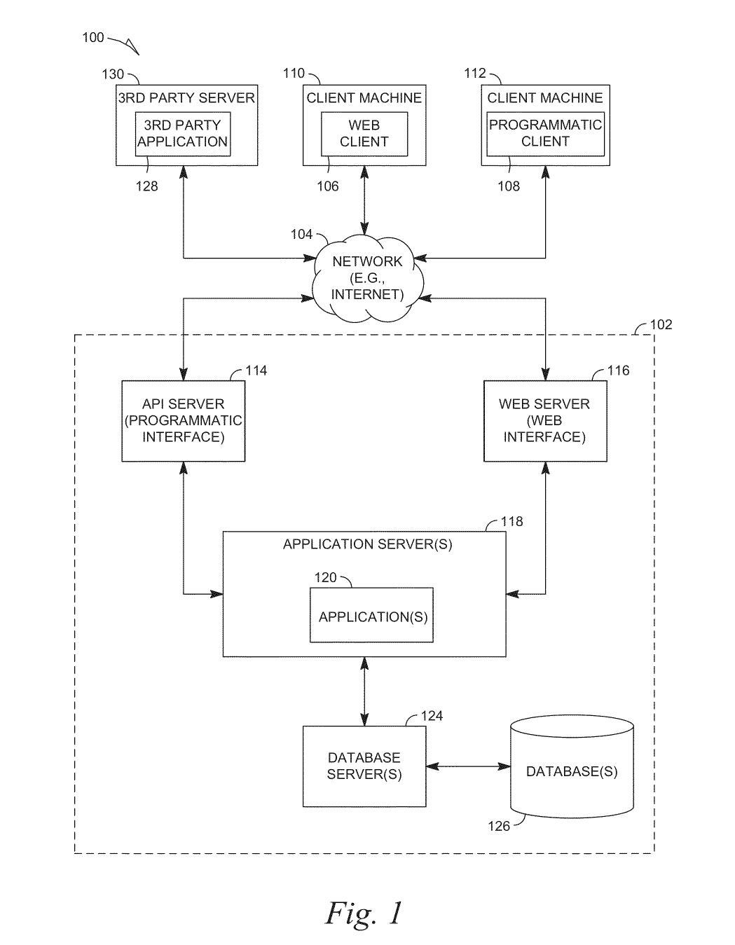

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

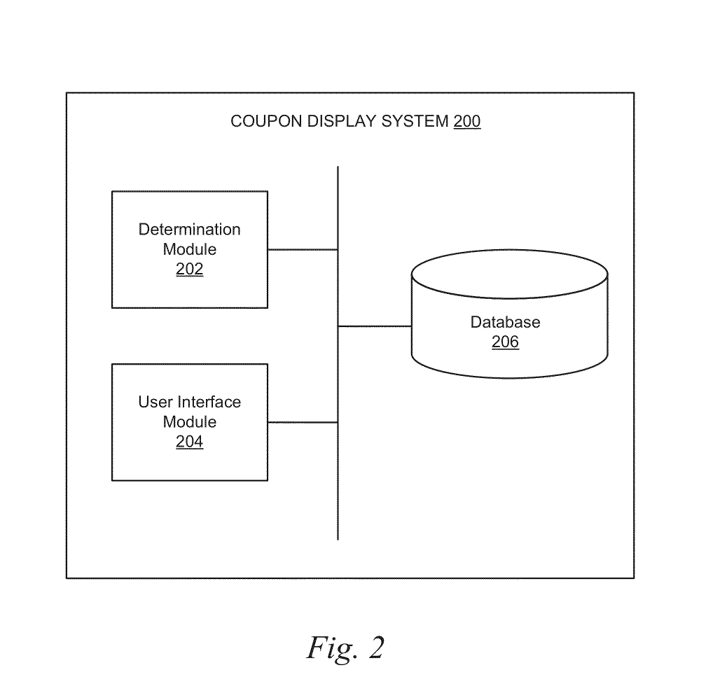

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may correspond to one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a coupon display system 200 includes a determination module 202, a user interface module 204, and a database 206. The modules of the coupon display system 200 may be implemented on a single device such as a coupon display device, or on separate devices interconnected via a network. The aforementioned coupon display device may correspond to, for example, one of the client machines (e.g. 110, 112) or application server(s) 118 illustrated in FIG. 1.

According to various embodiments described herein, the coupon display system 200 is configured to generate a display of coupons (e.g., via a user interface displayed on a user's smart phone) in a visual arrangement that illustrates how close the user is to each of the locations where the coupons may be redeemed. For example, the coupon display system 200 may display the coupons in a list, where coupons that may be redeemed at locations closer to the user are displayed near the top of the list, whereas coupons that may be redeemed at locations farther away from the user are displayed near the bottom of the list. As another example, the coupon display system 200 may display the coupons on a distance graph that visually illustrates the proximity of the user to the redemption locations associated with each of the coupons, as described in more detail below.

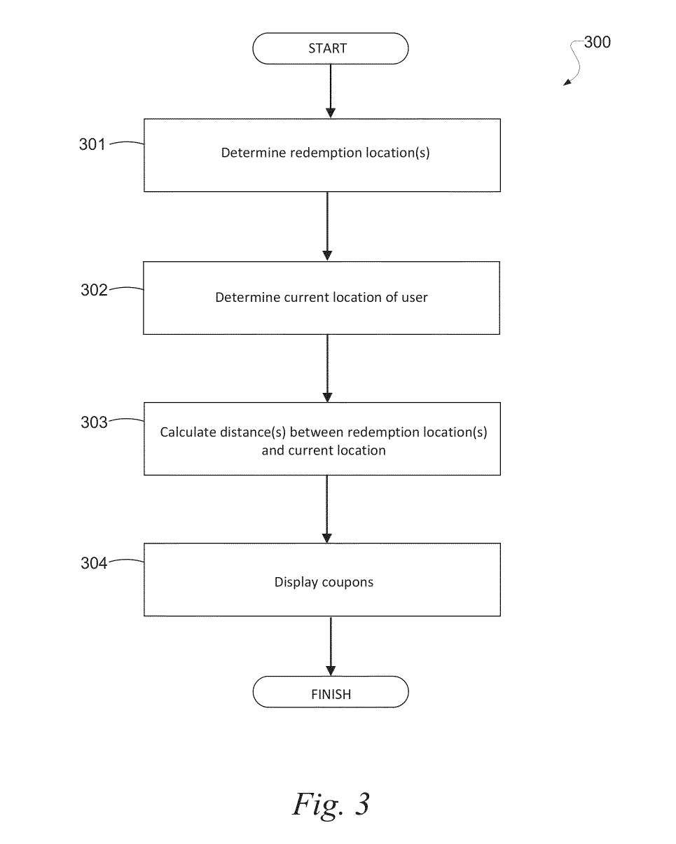

For example, FIG. 3 is a flowchart illustrating an example method 300, according to various embodiments. The method 300 may be performed at least in part by, for example, the coupon display system 200 illustrated in 2 (or an apparatus having similar modules, such as client machines 110 and 112 or application server 112 illustrated in FIG. 1). In 301, the determination module 202 determines a redemption location associated with each of one or more coupons. As described herein, a redemption location of a coupon corresponds to a location (e.g., retail store) where the coupon may be redeemed when purchasing a product or service. In 302, the determination module 202 determines a current location of a user or a mobile device of the user. For example, the determination module 202 may determine the current location of the mobile device based on geo-location information accessed from the mobile device associated with the user. In 303, the determination module 202 calculates, for each of the coupons, a distance between the redemption location of the respective coupon and the current location of the user. Put another way, the determination module 202 determines the distance between the user and the locations where each of the coupons may be redeemed.

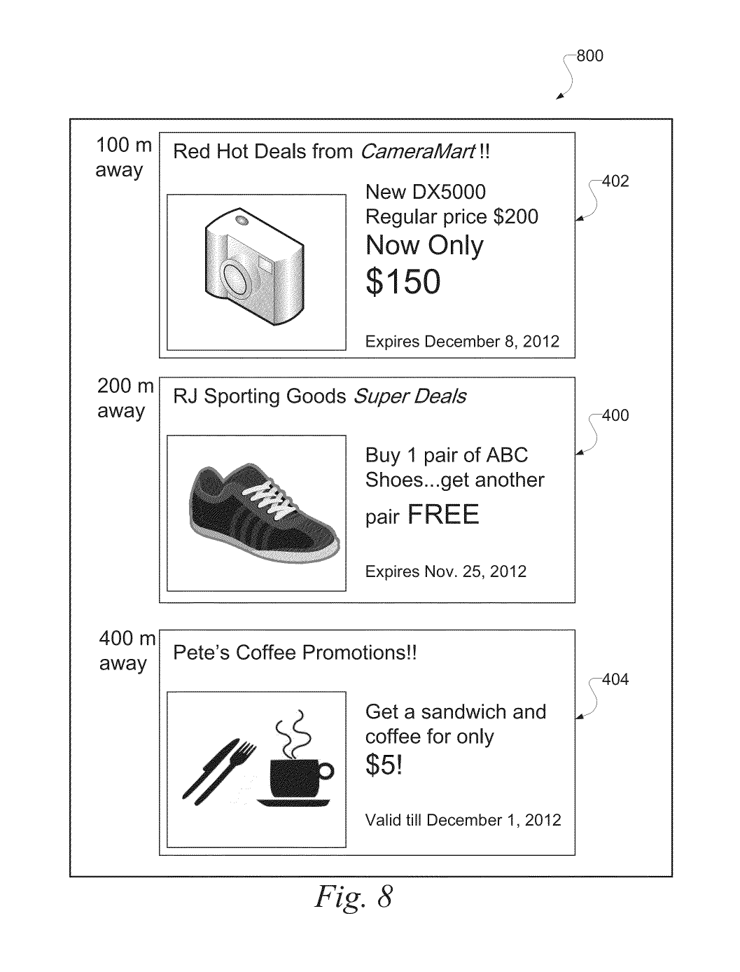

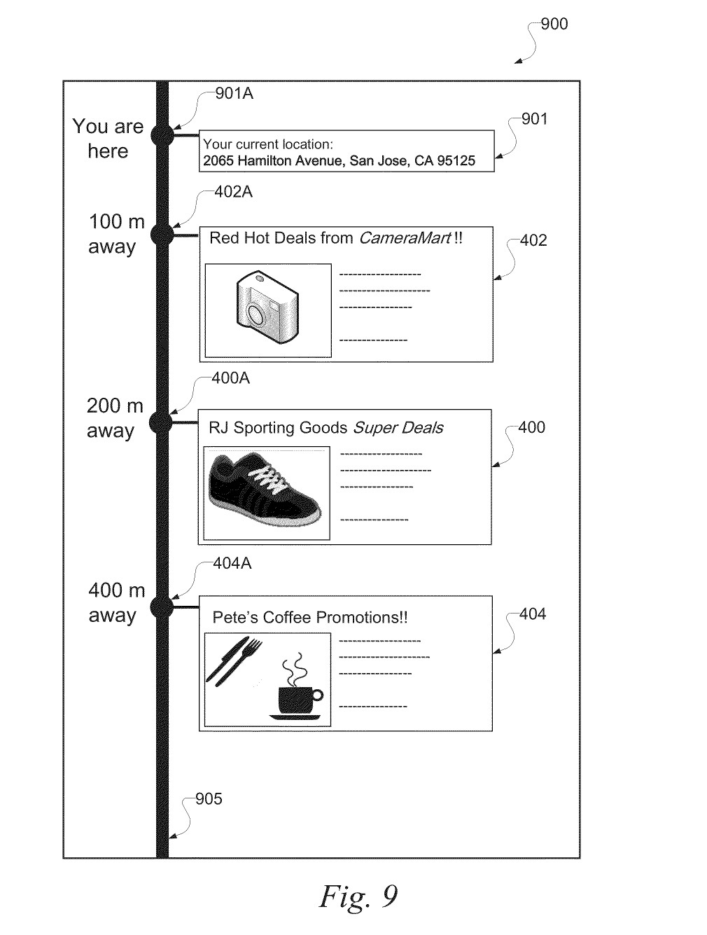

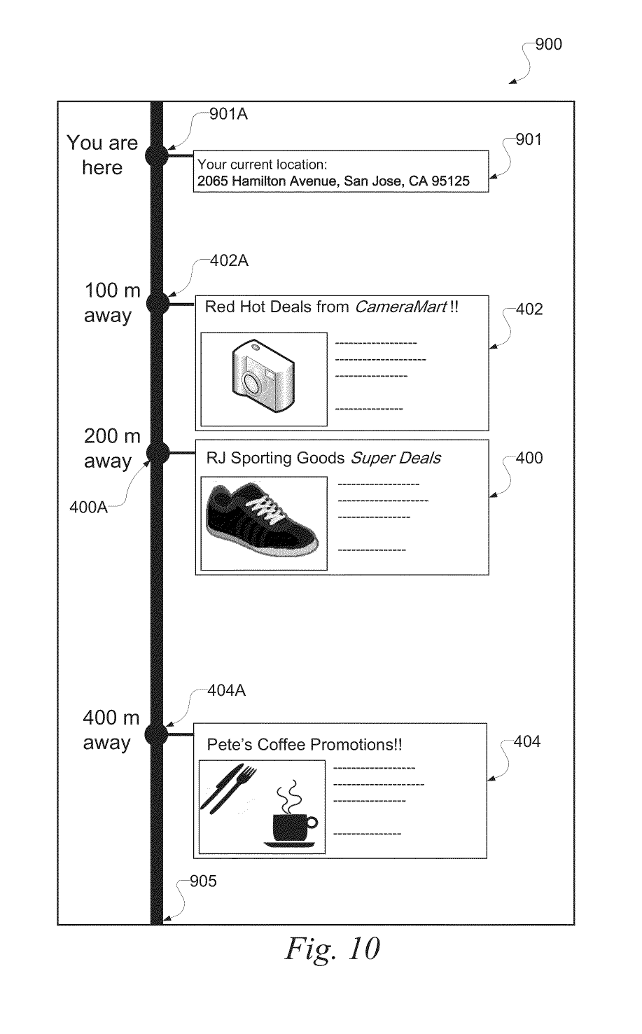

In 304, the user interface module 204 generates a display of the coupons in an arrangement that illustrates the proximity of the user to the locations where each of the coupons may be redeemed. For example, according to various embodiments, the user interface module 204 may cause the coupons to be displayed in an ordered coupon list (e.g., see FIG. 8), where the coupons in the list are ordered based on the respective distances (calculated in 303) associated with each of the coupons. As another example, according to various embodiments, the user interface module 204 may cause the coupons to be displayed as plot points at respective positions on a reference line (e.g., see FIGS. 9 and 10), based on the respective distances (calculated in 303) associated with each of the coupons. Each of the aforementioned operations 301-304, and each of the aforementioned modules of the coupon display system 200, will now be described in greater detail.

Referring back to FIG. 3, in 301, the determination module 202 determines a redemption location associated with each of one or more coupons. As described above, a redemption location of a coupon corresponds to a location where the coupon may be redeemed when purchasing a product or service. For example, if the coupon is issued by a retailer for use in the retailer's stores as part of a sales promotion, then in order to redeem the coupon and obtain the financial discount for a product being purchased, the consumer typically presents the coupon in the appropriate retail store at the time of purchase. Thus, in this example, such a retail store would correspond to the redemption location of the coupon. According to an embodiment, if the coupon includes an address directly within the text of the coupon, the determination module 202 may determine that this address is the redemption location associated with a coupon. For example, the determination module 202 may perform a text analysis of the content or information (e.g., text or words) included in the coupon, and search for text or words corresponding to an address.

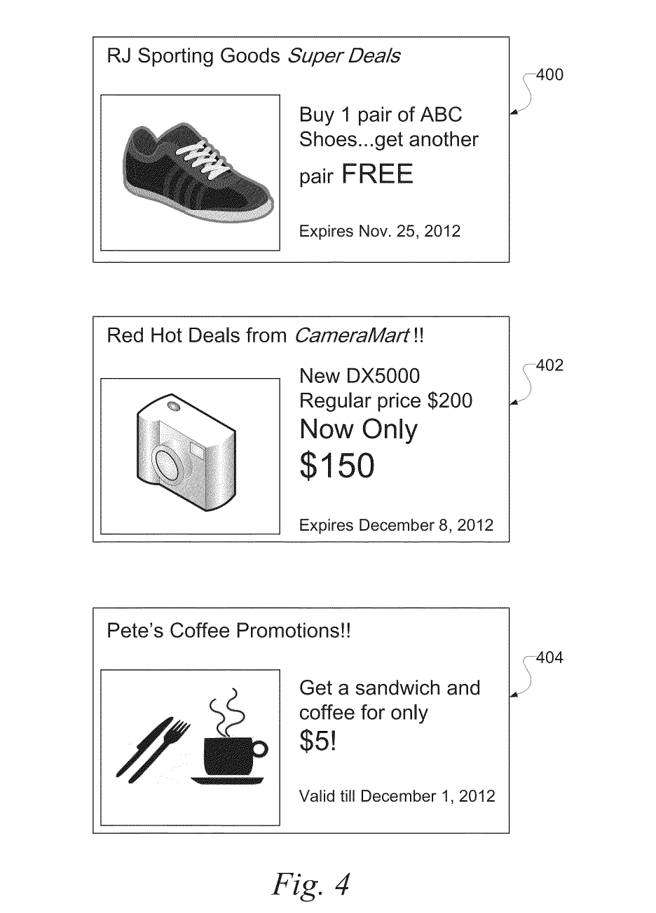

According to another embodiment, the determination module 202 may determine a redemption location associated with a coupon, by (a) determining a retailer (or other entity, such as a business, enterprise, organization, etc.) associated with the coupon, and (b) determining a location associated with this retailer. For example, FIG. 4 illustrates three exemplary coupons 400, 402, and 404 that include text and images. The coupon 400 is issued by the retailer RJ Sporting Goods, the coupon 402 is issued by the retailer CameraMart, and the coupon 404 is issued by the retailer Pete's Coffee. (While examples throughout refer to three exemplary coupons 400, 402, and 404 in the interests of clarity, it should be understand that the aspects described herein are applicable to any number of coupons). Thus, using the coupon 400 as an example, the determination module 202 may determine the redemption location associated with the coupon 400 by (a) determining that the coupon 400 is associated with the retailer RJ Sporting Goods, and then (b) determining a location associated with retailer Sporting Goods.

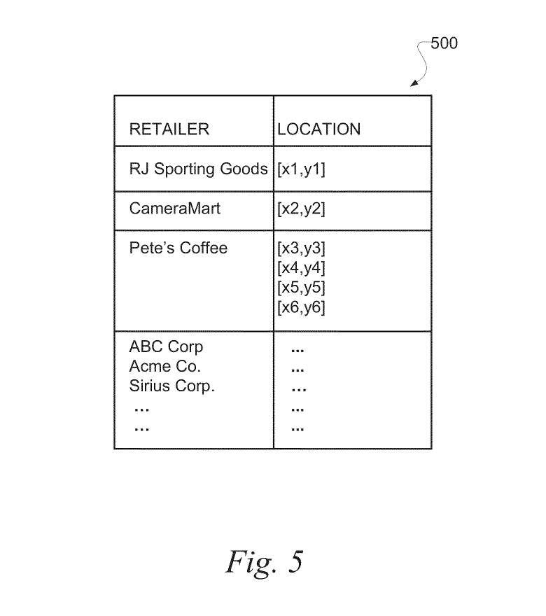

The determination module 202 may determine a retailer associated with a coupon by performing a text analysis of the content or information (e.g., text or words) included in the coupon, and searching for keywords corresponding to the name of a retailer. For example, the determination module 202 may access a list of retailers, in order to determine if any of these retailers in the list are referenced by the text of the coupon 400. The aforementioned list may be embodied as retailer information 500 as shown in FIG. 5, which includes the names of various retailers. The retailer information 500 may, for example, be stored in database 206 illustrated in FIG. 2, or may be accessed from a remote location via a network (e.g., the Internet). Thus, if the words in the name of a retailer listed in the retailer information 500 (e.g., “RJ” and “Sporting” and “Goods”) are detected by the determination module 202 in the coupon 400 through text analysis, the determination module 202 may determine that the corresponding retailer in the retailer information 500 (i.e., “RJ Sporting Goods”) is associated with the coupon 400.

Note that in the text analysis operation described above, electronic data corresponding to a coupon (e.g., a file of electronic data including the text data of the coupon and including the image data of the coupon, etc.) may be accessed by the determination module 202 in order to determine the retailers associated with each of the coupons. For example, a coupon (or the electronic data corresponding to the coupon) may be downloaded by the coupon display system 200 from an Internet website, or received by the coupon display system 200 via various communication protocols such as e-mail, text message (including SMS and MMS messages), instant message, and so on. Instead or in addition, electronic data corresponding to a coupon may be generated based on scanned image data and/or optical character recognition (OCR) data generated based on scanning a hardcopy of the coupon. The aforementioned electronic data corresponding to each of the coupons 400-404 may be stored in the database 206 illustrated in FIG. 2.

After the determination module 202 determines a retailer associated with the coupon, the determination module 202 may determine the location associated with the retailer (i.e., the redemption location) by accessing information indicating a plurality of retailers and locations associated with each of the retailers. For example, the aforementioned retailer information 500 of FIG. 5 lists a plurality of retailers (e.g., RJ Sporting Goods, CameraMart, etc.), and locations associated with each of the retailers (e.g., [x1, y1], [x2, y2], etc.). The locations in the retailer information 500 illustrated in FIG. 5 are represented by exemplary generic location coordinates (e.g., [x1, y1]), which may correspond to geographic coordinates, global positioning system (GPS) coordinates, latitude & longitude coordinates, street addresses, etc., or any other metric for measuring or describing location that are known by those skilled in the art.

Thus, in the example above, the determination module 202 may determine that the redemption location associated with the coupon 400 is [x1, y1], by determining that the coupon 400 is associated with the retailer RJ Sporting Goods, and by determining that the retailer RJ Sporting Goods is associated with the location [x1, y1]. Similarly, the determination module 202 may determine that the redemption location associated with the coupon 402 is [x2, y2]. Note that a retailer may be associated with multiple locations (such as multiple branches or franchises in retail chain). For example, as illustrated in the retailer information 500, the retailer Pete's Coffee is associate with multiple locations: [x3, y3], [x4, y4], [x5, y5]. In this case, the determination module 202 may identify the location closest to the current location of the user as the corresponding retailer location (i.e., the redemption location associated with the coupon). Examples of how the current location of the user may be determined are described in more detail below. In this example, if the Pete's Coffee location [x3, y3] is closest to the current location of the user (when compared to the Pete's Coffee locations [x4, y4] and [x5, y5]), then the determination module 202 will determine that the redemption location associated with the coupon 404 is [x3, y3].

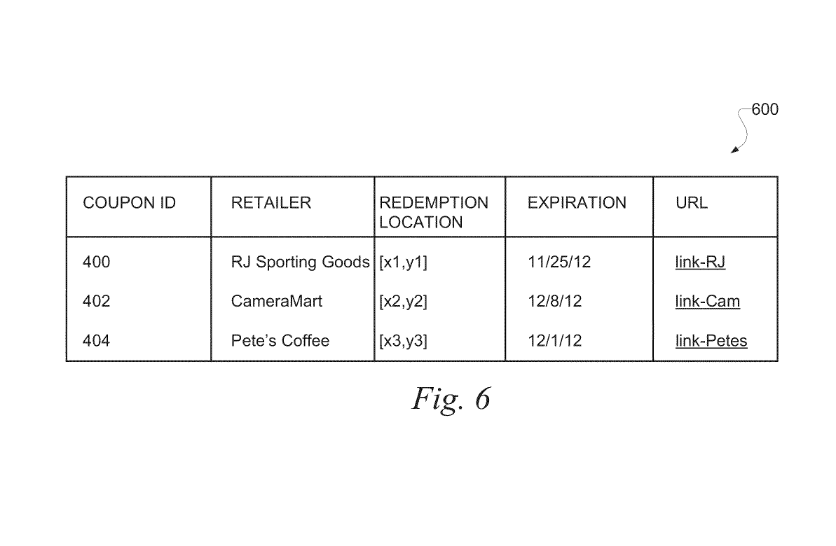

The determination module 202 may record the determined retailers and redemption locations associated with each coupon in coupon management information that describes various information about each of the coupons. For example, FIG. 6 illustrates an example of coupon management information 600 that lists, for a plurality of coupons, a coupon ID associated with each coupon, as well as a retailer associated with each coupon, a redemption location associated with each coupon, an expiration date associated with each coupon, and a URL for accessing the electronic data corresponding to the coupon (e.g., an electronic file such as a HTML file or XML file containing the text data and the image data of the coupon). The coupon management information 600 may be stored in, for example, database 206 illustrated in FIG. 2. (The expiration dates in the coupon management information 600 are described in more detail elsewhere in this disclosure.)

Referring back to FIG. 3, in 302, the determination module 202 determines a current location of a user. For example, the determination module 202 may determine the current location of the user based on geo-location information accessed from a mobile device associated with the user (e.g., client machines 110, 112 illustrated FIG. 1). The geo-location information may be generated by the mobile device based on, for example, a GPS system included in the mobile device, or a location module of the mobile device that performs an analysis of signal strength from nearby telecommunications towers proximate to the mobile device, or other methods well understood by those skilled in the art.

In 303 in FIG. 3, the determination module 202 calculates, for each coupon, a distance between the redemption location of the respective coupon and the current location of the user. Put another way, the determination module 202 determines the distance between the user and the locations where each of the coupons may be redeemed. For instance, in the example above, the determination module 202 determined that the redemption location associated with the coupon 400 is [x1, y1]. Suppose that the determination module 202 determined in 302 that the current location of the user is [x0, y0]. Thus, in 303, the determination module 202 will calculate the distance between the redemption location [x1, y1] of the coupon 400 and the current location of the user [x0, y0].

The method by which the determination module 202 calculates the distance between two locations is not limited. For example, conventional mapping applications, such as GPS systems, are routinely able to calculate such distances between two points (e.g., the distance between two street addresses or the distance between two geographic co-ordinates), as understood by those skilled in the art. For example, web mapping service applications such as Google Maps (provided by Google®) have the functionality to calculate such distances, and offer APIs for accessing such functionalities. Such mapping applications are well understood by those skilled in the art, and shall not be described in further detail in the interests of brevity. Thus, the determination module 202 may include—or access the functionality of—such mapping applications, in order to determine the distance between the redemption location of the respective coupon (calculated in 301) and the current location of the user (calculated in 302). In one embodiment, the determination module 202 may determine the straight line distance between the redemption location of the respective coupon and the current location of the user. In another embodiment, the determination module 202 may determine the distance of a shortest travel route (e.g., walking routing, driving, route, public transport route, etc.) for travelling from the user's current location to the redemption location of the coupon.

Thus, in 303, the determination module 202 calculates, for each coupon, a distance between the redemption location of the respective coupon and the current location of the user. For example, the determination module 202 will calculate the distance between the redemption location [x1, y1] of the coupon 400 and the current location of the user [x0, y0], the distance between the redemption location [x2, y2] of the coupon 402 and the current location of the user [x0, y0], the distance between the redemption location [x3, y3] of the coupon 404 and the current location of the user [x0, y0], and so on.

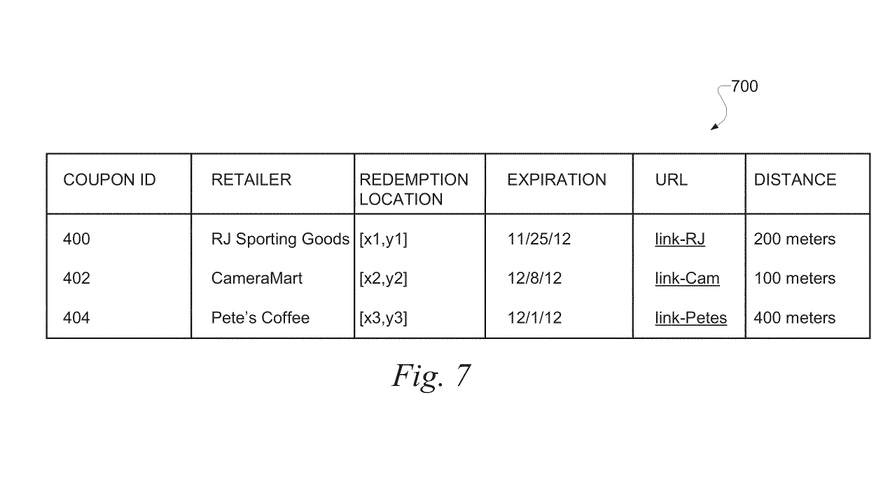

The determination module 202 may store the calculated distances in the aforementioned coupon management information (see FIG. 6) that describes information about each of the coupons. For example, FIG. 7 illustrates an example of coupon management information 700 that is similar to the coupon management information 600 illustrated in FIG. 6, where the determination module 202 has listed, for each coupon, the distances between the redemption location of that coupon and the current location of the user. In the non-limiting example of FIG. 7, the determination module 202 has determined that: the distance between the redemption location of the coupon 400 and the current location of the user is 200 m; the distance between the redemption location of the coupon 402 and the current location of the user is 100 m; and the distance between the redemption location of the coupon 404 and the current location of the user is 400 m. Thus, the coupon 402 is associated with the redemption location that is closest to the user, while the coupon 404 is associated with the redemption location that is farthest from the user.

In 304, the user interface module 204 displays (via a user interface) the coupons in an arrangement that illustrates the proximity of the user to the locations where each of the coupons may be redeemed.

For example, according to various embodiments, the user interface module 204 may display the coupons in and ordered coupon list, where the coupons in the list are ordered based on the respective distances associated with each of the coupons (as calculated in 303). FIG. 8 illustrates an example of an ordered coupon list 800 that may be displayed by the user interface module 204 via a user interface on, for example, a user's mobile device (e.g., client machines 110, 112 illustrated in FIG. 1). The list 800 includes the coupons 400, 402 and 404 displayed in their entirety. Alternatively, the list 800 my display only a portion of each coupon (e.g., coupon title, coupon picture, a thumbnail of the coupon, etc.). Since the coupon 402 is associated with the redemption location that is closest to the user, the coupon 402 is displayed at the top of the list. On the other hand, since the coupon 404 is associated with the redemption location that is the farthest away from the user, the coupon 404 is displayed at the bottom of the list 800. Thus, the coupons in the list are ordered, based on the proximity of the user to the redemption locations of the coupons. Accordingly, when the user views the ordered coupon list 800, the user can immediately determine which coupons may be redeemed at the locations near the user. As illustrated in FIG. 8, the list 800 may display the distances between the redemption location of each coupon and the current location of the user (e.g., redemption location of coupon 402=“100 m away”).

As another example, according to various embodiments, the user interface module 204 may display the coupons in a distance graph that depicts the coupons as plot points on a reference line, based on the proximity of the user to the redemption locations of the coupons. For example, FIG. 9 illustrates an example of a distance graph 900 that may be displayed by the user interface module 204 via a user interface on, for example, the user's mobile device (e.g., client machines 110, 112 illustrated in FIG. 1). The distance graph 900 depicts the coupons 400, 402 and 404 in a similar manner to the ordered coupon list 800 described above; i.e. in an ordered arrangement that is ordered based on based on the proximity of the user to the redemption locations of the coupons. For example, since the coupon 402 is associated with the redemption location that is closest to the user, the coupon 402 is displayed above the other coupons 400 and 404 in the distance graph 900. On the other hand, since the coupon 404 is associated with the redemption location that is the farthest away from the user, the coupon 404 is displayed near the bottom of the distance graph 900. The coupons 400-404 in the distance graph 900 may be displayed in their entirety, although in FIG. 9, the detail included in each of the coupons 400-404 is reduced in the interests of clarity. Alternatively, the distance graph 900 may display only a portion of each coupon (e.g., coupon title, coupon picture, a thumbnail of the coupon, etc).

Moreover, the distance graph 900 also includes a reference line 905 that represents distance from the current location of the user, such that respective plot points 400A-404A plotted on the reference line 905 indicate respective distances from the current location from the user. For example, the current location of the user may be identified in the current location window 901 that is plotted as a plot point 901A near the top of the reference line 905. Each of the coupons 400, 402, and 404 are then plotted as plot points 400A, 402A, and 404A, respectively, at positions on the reference line 905. The plot points 400A, 402A, and 404A represents the distance between the redemption locations associated with each of the coupons 400, 402, and 404 and the current location of the user (represented by the plot point 901A) and. As illustrated in FIG. 9, the distance graph 900 may list the distances between the redemption location of each coupon and the current location of the user (e.g., “100 m away”) near the plot points 400A-404A plotted on the reference line 905.

The reference line 905 in FIG. 9 need not represent a linear scale of distance. That is, the distance between the plot points 402A, 400A, and 404A and the plot point 901A on the reference line 905 are not proportional to the distances between the redemption locations of each of the corresponding coupons 400-404 and the current location of the user. However, according to another exemplary embodiment, the reference line 905 may represent distance on a linear scale. For example, FIG. 10 illustrates the distance graph 900, where each of the coupons 400, 402, and 404 are plotted as plot points 400A, 402A, and 404A, respectively, at respective positions on a reference line 905. The reference line 905 represents distance from the current location of the user on a linear scale. That is, a given interval on the reference line 905 (e.g. 10 cm) corresponds to a specific distance from the current location of the user (e.g., 100 m). Thus, since the redemption location of the coupon 402 is 100 m away from the current location of the user, the corresponding plot point 402A may be plotted 10 cm away on the reference line 905 from the current location of the user represented by the plot point 901A. As another example, since the redemption location of the coupon 404 is 400 m away from the current location of the user, the corresponding plot point 404A may be plotted 10 cm away on the reference line 905 from the current location of the user represented by the plot point 901A. Thus, the positions of the plot points 400A, 402A, and 404A on the reference line 905 in FIG. 10 represent distance from the current location of the user, based on a linear scale.

While the current location of the user may be represented by the current location window 901 that is plotted as a plot point 901A near the top of the reference line 905, according to another embodiment, the current location of the user may simply be represented by an end or endpoint of the reference line 905, such as the upper end of the reference line 905 at the top of the distance graph 900.

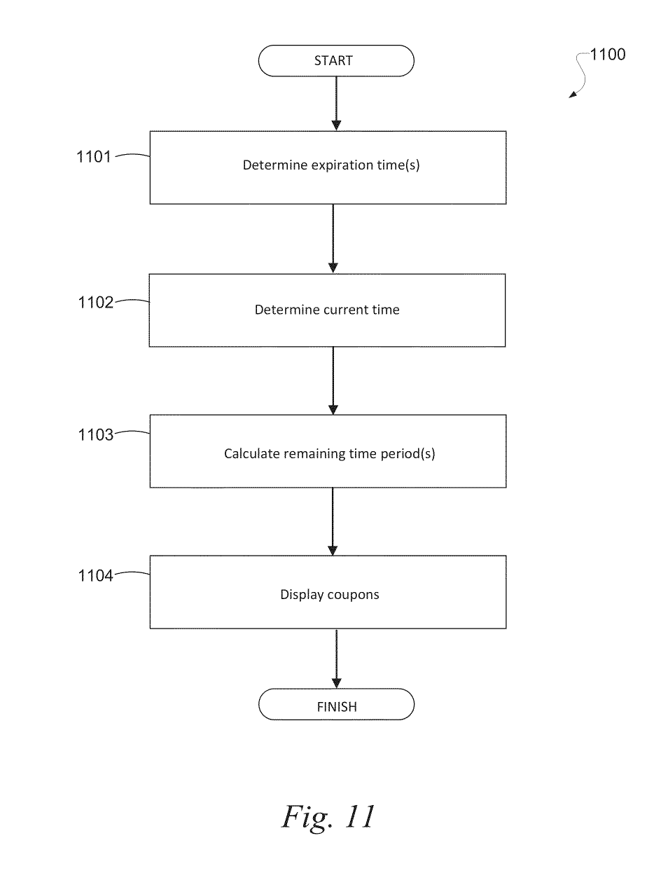

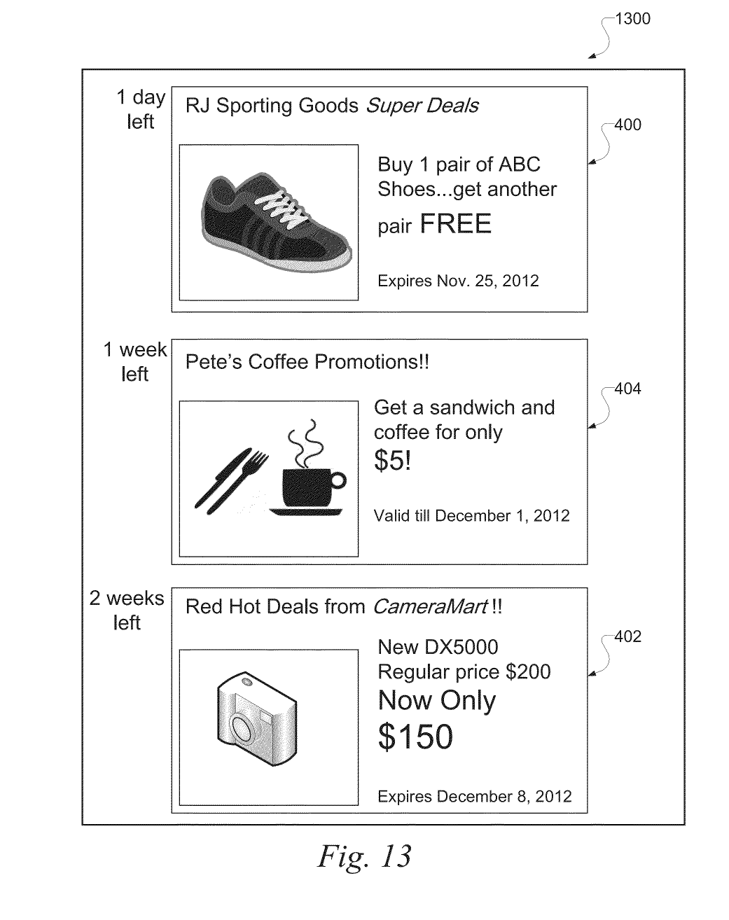

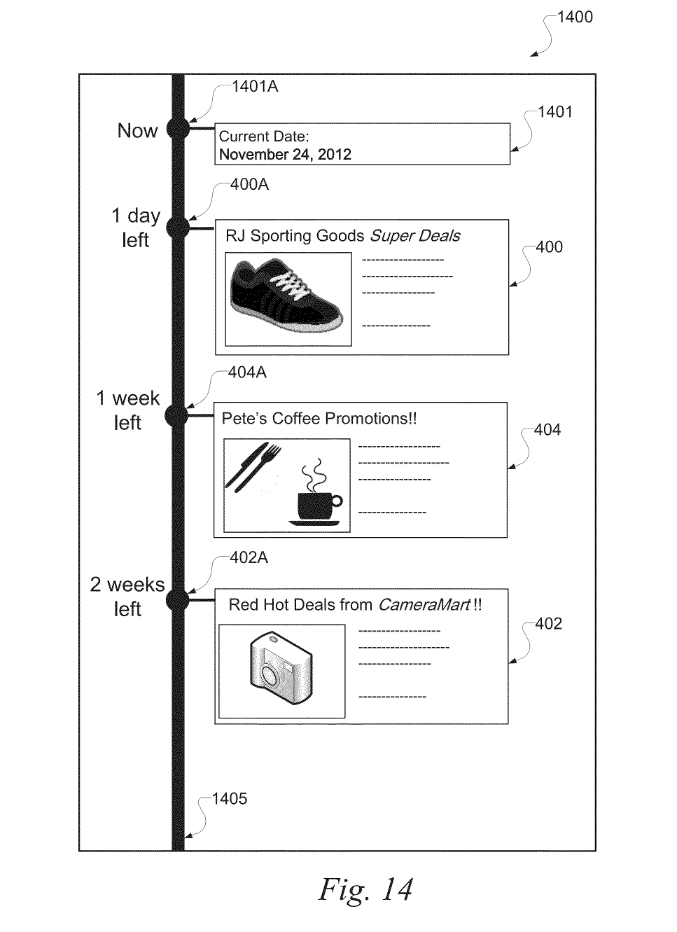

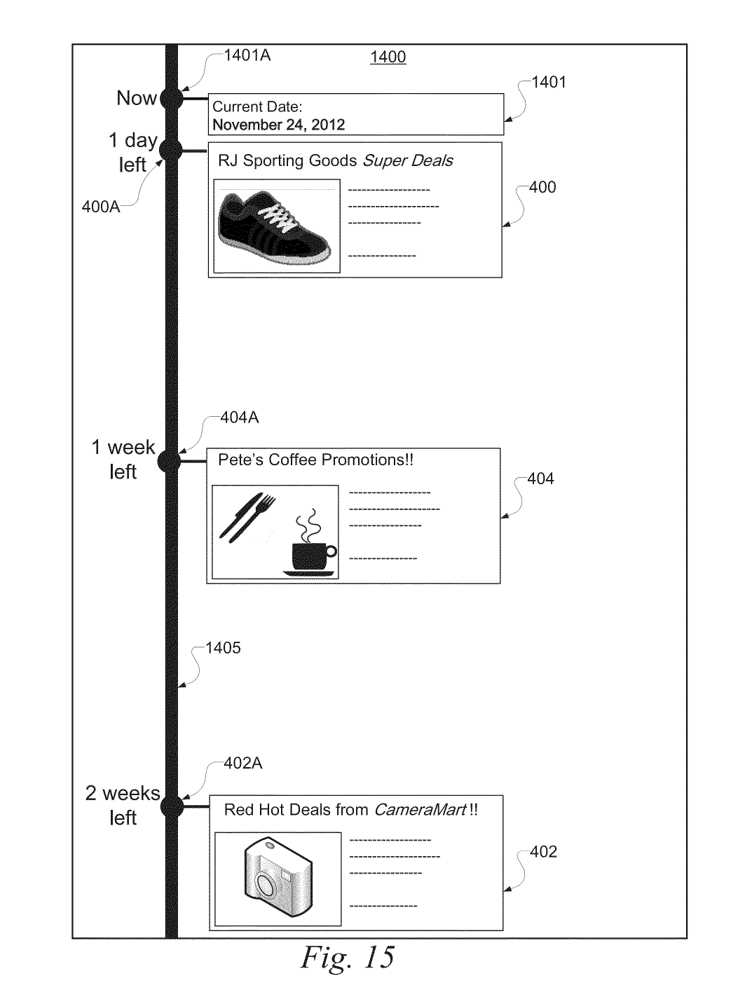

Turning now to FIGS. 11-15, according to various embodiments described herein, the coupon display system 200 is also configured to display coupons to a user (e.g., via a user interface displayed on a user's smart phone) in a visual arrangement that illustrates how much time is left before each coupon expires. For example, the coupon display system 200 may display the coupons in a list (e.g., see FIG. 13), where coupons that expire the soonest are displayed near the top of the list, whereas coupons that latest are displayed near the bottom of the list. As another example, 200 may display the coupons on a time graph (e.g., see FIGS. 14 and 15) that visually illustrates the expiration dates associated with each of the coupons.

For example, FIG. 11 is a flowchart illustrating an example method 1100, according to various embodiments. The method 1100 may be performed at least in part by, for example, the coupon display system 200 illustrated in FIG. 2 (or an apparatus having similar modules, such as client machines 110 and 112 or application server 112 illustrated in FIG. 1).

In 1101, the determination module 202 determines an expiration time and/or date associated with each of one or more coupons. According to an embodiment, the determination module 202 may deter an expiration time associated with a coupon by performing a text analysis of the content or information (e.g., text or words) included in the coupon, and searching for keywords or characters indicative of an expiration date. For example, the determination module 202 locate the words “expire”, “expires”, “expiration”, “valid until”, etc., in the coupon, and any times or dates Wowing such words (e.g., “Nov. 25, 2012”, or “11/25/12”) may be identified by the determination module 202 as the expiration time/date associated with the coupon. Thus, the determination module 202 may determine that the expiration time of the coupon 400 is Nov. 25, 2012, while the expiration time of the coupon 402 is Dec. 8, 2012, while the expiration time of the coupon 404 is Dec. 1, 2012. The expiration times/dates determined by the determination module 202 may be reflected in coupon management information 600 (see FIG. 6).

Returning to FIG. 11 in 1102, the determination module 202 determines a current time and/or date. For example, the determination module 202 may determine the current time from an application installed on a mobile device associated with the user, as well understood by those skilled in the art.

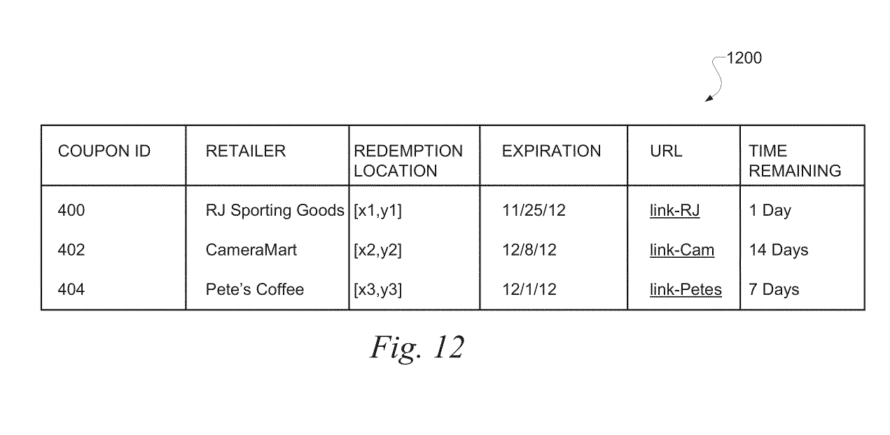

In 1103, the determination module 202 calculates, for each of the coupons, a remaining time period before the respective coupon expires. For example, the determination module 202 calculates the difference between the expiration time of the respective coupon (determined in 1101) and the current time (determined in 1102). The determination module 202 may store the calculated distances in the aforementioned coupon management information (see FIG. 6) that describes information about each of the coupons. For example, FIG. 12 illustrates an example of coupon management information 1200 that is similar to the coupon management information 600 illustrated in FIG. 6, where the determination module 202 has listed, for each coupon, a remaining time period before the expiration date of the respective coupon. In the non-limiting example of FIG. 12, the determination module 202 has determined that the coupon 400 expires in 1 day, the coupon 402 expires in 14 days, and the coupon 404 expires in 7 days.

Returning to FIG. 11, in 1104, the user interface module 204 displays the coupons in an arrangement that illustrates how much time is left before each coupon expires. For example, according to various embodiments, the user interface module 204 may display the coupons in an ordered coupon list, where the coupons in the list are ordered based on the remaining time periods associated with each of the coupons (as calculated in 1103). FIG. 13 illustrates an example of an ordered coupon list 1300 that may be displayed by the user interface module 204 via a user interface on, for example, a user's mobile device (e.g., client machines 110, 112 illustrated in FIG. 1). The list 1300 includes the coupons 400, 402 and 404 displayed in their entirety. Alternatively, the list 1300 may display only a portion of each coupon (e.g., coupon title, coupon picture, a thumbnail of the coupon, etc.). Since the coupon 400 expires the soonest, the coupon 400 is displayed at the top of the list 1300. On the other hand, since the coupon 402 expires the latest, the coupon 402 is displayed at the bottom of the list 1300. Thus, the coupons in the list are ordered, based on how much time remains before each of the coupons expire. According, when the user views the ordered coupon list 1300, the user can immediately determine which coupons expire soonest. As illustrated in 13, the list 1300 may display the remaining time periods associated with each of the coupons (e.g., “2 weeks left”).

As another example, according to various embodiments, the user interface module 204 may display the coupons in a time graph that visually illustrates the expiration dates associated with each of the coupons. For example, FIG. 14 illustrates an example of a time graph 1400 that may be displayed by the user interface module 204 via a user interface on, for example, a user's mobile device (e.g., client machines 110, 112 illustrated in FIG. 1). The time graph 1400 depicts the coupons 400, 402 and 404 in a similar manner to the ordered coupon list 1300 described above; i.e. in an ordered arrangement that is ordered based on how much time remains before each of the coupons expire. For example, since the coupon 400 expires the soonest, the coupon 400 is above the other coupons 402 and 404 in the time graph 1400. On the other hand, since the coupon 402 expires the latest, the coupon 402 is displayed near the bottom of the time graph 1400. The coupons 400-404 in the time graph 1400 may be displayed in their entirety, although in FIG. 14, the detail included in each of the coupons 400-404 is reduced in the interests of clarity. Alternatively, the time graph 1400 may display only a portion of each coupon (e.g., coupon title, coupon picture, a thumbnail of the coupon, etc.).

Moreover, the time graph 1400 also includes a reference line 1405 that represents remaining time before coupon expiration, such that respective points plotted on the reference line 905 indicate respective remaining time periods. For example, the current time may be identified in the current time window of 1401 that is plotted as a plot point 1401A near the top of the reference line 1405. Each of the coupons 400, 402, and 404 are then plotted as plot points 400A, 402A, and 404A, respectively, at positions on the reference line 1405. The plot points 400A, 402A, and 404A represents the time remaining before expiration of each of the coupons 400, 402, and 404. As illustrated in FIG. 14, the time graph 1400 may also list the time remaining before expiration of each coupon (e.g., “2 weeks left”) near the plot points 400A-404A plotted on the reference line 1405.

The reference line 1405 in FIG. 14 need not represent a linear scale of time. However, according to another exemplary embodiment, the reference line 1405 may represent time on a linear scale. For example, FIG. 15 illustrates the time graph 1400, where each of the coupons 400, 402, and 404, plotted as plot points 400A, 402A, and 404A, respectively, at respective positions on the reference line 1405. The reference line 1405 represents remaining time before coupon expiration, based on a linear scale. That is, a given interval on the reference line 1405 (e.g. 1 inch) corresponds to a time period before expiration (e.g., one day). Thus, since the coupon 400 expires in one day, the corresponding plot point 402A may be plotted 1 inch away on the reference line 1405 from the current time represented by the plot point 1401A. As another example, since the coupon 404 expires in one week or seven days, the corresponding plot point 404A may be plotted 7 inches away on the reference line 1405 from the current time represented by the plot point 1401A. Thus, the positions of the plot points 400A, 402A, and 404A on the reference line 1405 in FIG. 15 represent remaining time before coupon expiration, based on a linear time scale.

While the current time may be represented by the current time window 1401 that is plotted as a plot point 1401A near the top of the reference line 1405, according to another embodiment, the current time may simply be represented by an end or endpoint of the reference line 1405, such as the upper end of the reference line 1405 at the top of the time graph 1400.

According to various exemplary embodiments, the distance graphs and time graphs described throughout may include additional information then depicted in the figures. For example, according to an embodiment, coupons displayed in a distance graphs or time graph may be altered visually at the time of display to indicate that the corresponding redemption location is now closed. For example, a particular coupon may be grayed out when the 202 determines that the corresponding redemption location is close to the time of display. According to another exemplary embodiment, a coupon displayed in the distance graph what time graph may include an indicator of the number of other people that have redeemed the same coupon, and/or the number of the user's friends that have redeemed the same coupon (e.g., e-mail contacts in the user's in the contact list, more connections or friends of the user's social media). According to another exemplary embodiment, the distance graphs and time graphs may also display/share buttons next to each of the coupons to allow the user to forward that coupon to their friends (e.g., to the specified e-mail address or social media handle). According to another exemplary embodiment, the distance graphs and time graphs may display the locations of the user's friends as plot points on the corresponding graph. For example, the determination module 202 may access a server storing information regarding the locations of the mobile devices of multiple users. The 202 may compare this information was a list of the user's friends (e.g., e-mail contacts in the user's in the contact list, more connections or friends of the user's social media), and determine whether any of the friends are close to any of the stores. If so, the user interface module 204 displays a corresponding friend icon on the reference line in the distance graph and/or time graph to show which store they are close to.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

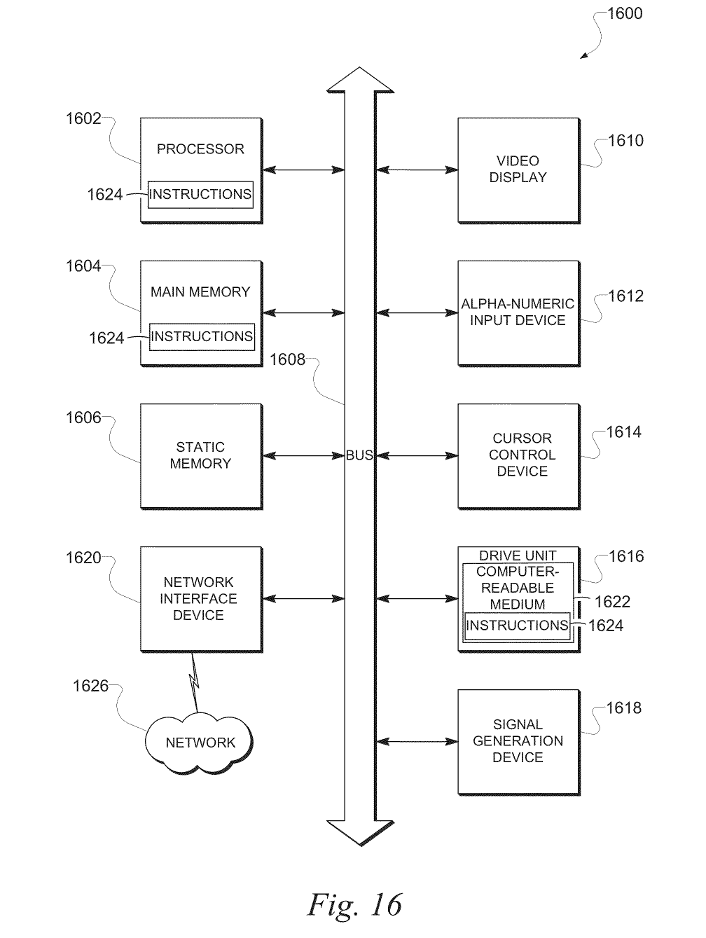

FIG. 16 is a block diagram of machine in the example form of a computer system 1600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard or a touch-sensitive display screen), a user interface (UI) navigation device 1614 (e.g., a mouse), a disk drive unit 1616, a signal generation device 1618 (e.g., a speaker) and a network interface device 1620.

### Machine-Readable Medium

The disk drive unit 1616 includes a machine-readable medium 1622 on which is stored one or more sets of instructions and data structures (e.g., software) 1624 embodying or utilized by any one or more of the methodologies or functions described herein. The instructions 1624 may also reside, completely or at least partially, within the main memory 1604 and/or within the processor 1602 during execution thereof by the computer system 1600, the main memory 1604 and the processor 1602 also constituting machine-readable media.

While the machine-readable medium 1622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
determining a redemption location associated with each of one or more coupons;
determining a current location of a mobile device of a user;
calculating, for each of the coupons, a distance between the redemption location of the respective coupon and the current location of the mobile device of the user; and
generating a display of the coupons, via a user interface in the mobile device, in an ordered coupon list, the coupons in the list being ordered based on the respective distances associated with each of the coupons.

2. The method of claim 1, wherein a specific one of the coupons associated with the smallest distance is displayed at a top position in the list.

3. The method of claim 1, wherein a specific one of the coupons associated with the largest distance is displayed at a bottom position in the list.

4. The method of claim 1, wherein the coupons are displayed as plot points at respective positions on a reference line, based on the respective distances associated with each of the coupons.

5. The method of claim 4, wherein the respective positions on the reference line represent distances from the current location of the user based on a linear scale.

6. The method of claim 4, wherein a start point of the reference line represents the current location of the user.

7. The method of claim 4, wherein the current location of the user is plotted on the reference line.

8. The method of claim 4, wherein the calculated distances associated with each of the coupons are displayed adjacent to the respective positions on the reference line.

9. The method of claim 4, wherein the current location of the user is determined based on geo-location information accessed from a mobile device associated with the user.

10. The method of claim 4, wherein the coupons plotted on the reference line are displayed in their entirety.

11. An apparatus comprising:
a determination module configured to:
determine a redemption location associated with of one or more coupons;
determine a current location of a mobile device of a user; and
calculate, for each of the coupons, a distance between the redemption location of the respective coupon and the current location of the mobile device of the user; and
a user interface module configured to generate a display of the coupons, via a user interface in the mobile device, in an ordered coupon list, the coupons in the list being ordered based on the respective distances associated with each of the coupons.

12. The apparatus of claim 11, wherein a specific one of the coupons associated with the smallest distance is displayed at a top position in the list.

13. The apparatus of claim 11, wherein a specific one of the coupons associated with the largest distance is displayed at a bottom position in the list.

14. The apparatus of claim 11, wherein the user interface module causes the coupons to be displayed as plot points at respective positions on a reference line, based on the respective distances associated with each of the coupons.

15. The apparatus of claim 14, wherein the respective positions on the reference line represent distances from the current location of the user based on a linear scale.

16. The apparatus of claim 14, wherein a start point of the reference line represents the current location of the user.

17. The apparatus of claim 14, wherein the user interface module causes the current location of the user to be plotted on the reference line.

18. The apparatus of claim 14, wherein the user interface module causes the calculated distances associated with each of the coupons to be displayed adjacent to the respective positions on the reference line.

19. The apparatus of claim 14, wherein the determination module determines the current location of the user based on geo-location information accessed from a mobile device associated with the user.

20. A non-transitory machine-readable storage medium having embodied thereon instructions executable by one or more machines to perform operations comprising:
determining a redemption location associated with each of one or more coupons;
determining a current location of a mobile device of a user;
calculating, for each of the coupons, a distance between the redemption location of the respective coupon and the current location of the mobile device of the user; and
generating a display of the coupons, via a user interface in the mobile device, in an ordered coupon list, the coupons in the list being ordered based on the respective distances associated with each of the coupons.
